(19) United States
(12) Patent Application Publication
(10) Pub. No.: US 2019/0351765 A1
(43) Pub. Date: Nov. 21, 2019

(54) SYSTEM AND METHOD FOR REGULATING THE OPERATING DISTANCE BETWEEN WORK VEHICLES

(71) Applicant: CNH Industrial America LLC, New Holland, PA (US)

(72) Inventor: Frank Rabusic, Mount Pleasant, WI (US)

(73) Assignee: CNH Industrial America LLC

(21) Appl. No.: 15/983,306

(22) Filed: May 18, 2018

(51) Int. Cl. B60K 31/00; G05D 1/02; A01D 41/127

(52) U.S. Cl. CPC B60K 31/0008; G05D 1/0257; G05D 1/0255; G05D 1/024; B60K 2031/0033; A01D 41/127; A01D 41/1278; G05D 2201/0201; B60K 2031/0025; G05D 1/0223

(57) ABSTRACT

In one aspect, a system for regulating the operating distance defined between work vehicles during the performance of field operations may include a sensor configured to emit an output signal for reflection off of a component of a first work vehicle or a second work vehicle and detect the reflected output signal as a return signal. A controller of the system may be configured to monitor an operating distance between the first and second work vehicles within the field based on data received from the sensor associated with at least one of the output signal or the return signal. Additionally, the controller may be configured to initiate a control action associated with adjusting a relative positioning between the first and second work vehicles within the field when it is determined that the monitored operating distance has fallen outside the predetermined operating distance range.

### FIELD

The present disclosure generally relates to work vehicles and, more particularly, to systems and methods of maintaining the operating distance defined between a first work vehicle, such as an agricultural harvester, and a second work vehicle, such as a crop receiving vehicle, during the performance of field operations.

### BACKGROUND

A harvester is an agricultural machine used to harvest and process crops. For instance, a combine harvester may be used to harvest grain crops, such as wheat, oats, rye, barley, corn, soybeans, and flax or linseed. In general, the objective is to complete several processes, which traditionally were distinct, in one pass of the machine over a particular part of the field. In this regard, most harvesters are equipped with a detachable harvesting implement, such as a header, which cuts and collects the crop from the field. The harvester also includes a crop processing system, which performs various processing operations (e.g., threshing, separating, etc.) on the harvested crop received from the harvesting implement. Furthermore, the harvester includes a crop tank, which receives and stores the harvested crop after processing.

In certain instances, the stored harvested crop is unloaded from the harvester into a nearby crop receiving vehicle. In such instances, the harvester may include a crop discharge tube through which the processed crops are conveyed from the crop tank to the crop receiving vehicle. In order for the crop discharge tube to be positioned such that the crops conveyed thereby are deposited into the crop receiving vehicle, the harvester and the crop receiving vehicle must be operated in close proximity to each other. As such, when the harvester makes a turn toward the crop receiving vehicle, there is a risk that the header of the harvesting implement may collide with the crop receiving vehicle.

Accordingly, an improved system and method for regulating the operating distance between work vehicles would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to a system for regulating the operating distance defined between work vehicles during the performance of field operations. The system may include a first work vehicle configured to perform an operation within a field and a second work vehicle configured to be maintained within a predetermined operating distance range relative to the first work vehicle as the first work vehicle is performing the operation within the field. The system may also include a sensor provided in operative association with one of the first work vehicle or the second work vehicle. The sensor may be configured to emit an output signal for reflection off of a component of the other of the first work vehicle or the second work vehicle and detect the reflected output signal as a return signal. Furthermore, the system may include a controller communicatively coupled to the sensor. The controller may be configured to monitor an operating distance between the first and second work vehicles within the field based on data received from the sensor associated with at least one of the output signal or the return signal. Additionally, the controller may be configured to initiate a control action associated with adjusting a relative positioning between the first and second work vehicles within the field when it is determined that the monitored operating distance has fallen outside the predetermined operating distance range.

In another aspect, the present subject matter is directed to a system for regulating the operating distance defined between work vehicles during the performance of field operations. The system may include an agricultural harvester having a harvesting implement configured to perform a harvesting operation within a field and a crop receiving vehicle configured to be maintained within a predetermined operating distance range relative to the harvester as the harvester is performing the harvesting operation within the field. The system may also include a sensor installed on the harvesting implement, with the sensor being configured to emit an output signal for reflection off of a component of the crop receiving vehicle and detect the reflected output signal as a return signal. Furthermore, the system may include a controller communicatively coupled to the sensor. The controller may be configured to monitor an operating distance between the harvester and the crop receiving vehicle within the field based on data received from the sensor associated with at least one of the output signal or the return signal. Additionally, the controller may be configured to initiate a control action associated with adjusting a relative positioning between the harvester and the crop receiving vehicle within the field when it is determined that the monitored operating distance has fallen outside the predetermined operating distance range.

In a further aspect, the present subject matter is directed to a method for regulating the operating distance defined between a first work vehicle and a second work vehicle during the performance of field operations. The first work vehicle may be configured to perform an operation within a field, and the second work vehicle may be configured to be maintained within a predetermined operating distance range relative to the first work vehicle as the first work vehicle is performing the operation within the field. The method includes operating, with a computing device, a first work vehicle such that the first work vehicle performs an operation within a field. The method may also include monitoring, with the computing device, an operating distance between the first and second work vehicles within the field based on data received from a sensor provided in operative association with one of the first work vehicle or the second work vehicle. The sensor may be configured to emit an output signal for reflection of a component of the other of the first work vehicle or the second work vehicle and detect the reflected output signal as a return signal. The data may be associated with at least one of the output signal or the return signal. Furthermore, the method may include initiating, with the computing device, a control action associated with adjusting a relative positioning between the first and second work vehicles within the field when it is determined that the monitored operating distance has fallen outside the predetermined operating distance range.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a top view of one embodiment of an agricultural harvester unloading harvested crop into a crop receiving vehicle in accordance with aspects of the present subject matter, particularly illustrating a lateral distance defined between the harvester and the crop receiving vehicle;

FIG. 3 illustrates a top view of another embodiment of an agricultural harvester unloading harvested crop into a crop receiving vehicle in accordance with aspects of the present subject matter, particularly illustrating a longitudinal distance defined between the harvester and the crop receiving vehicle;

FIG. 4 illustrates a schematic view of one embodiment of a system for regulating the operating distance defined between work vehicles during the performance of field operations in accordance with aspects of the present subject matter; and

FIG. 5 illustrates a flow diagram of one embodiment of a method for regulating the operating distance defined between work vehicles during the performance of field operations in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for regulating the operating distance between work vehicles, such as between an agricultural harvester and an associated crop receiving vehicle. Specifically, in several embodiments, a sensor of the disclosed system may be mounted on one of the vehicles (e.g., on a harvesting implement of the harvester). As such, the sensor may be configured to emit an output signal for reflection off of a component of the other vehicle (e.g., the crop receiving vehicle) and detect the reflected output signal as a return signal. Based on data indicative of the output and/or return signals, a controller of the disclosed system may be configured to monitor the operating distance (e.g., a lateral distance and/or longitudinal distance) between the vehicles. When it is determined that the monitored operating distance has fallen outside the predetermined operating distance range (thereby indicating that the vehicles are too close or too far apart), the controller may be configured to initiate a control action associated with adjusting a relative positioning between the first and second work vehicles within the field. For example, in one embodiment, when the lateral distance between the vehicles falls below a minimum threshold lateral distance, the controller may be configured to adjust a steering parameter of one or both vehicles, such as by limiting the rate at which the vehicles may steer toward each other or otherwise change their direction of travel.

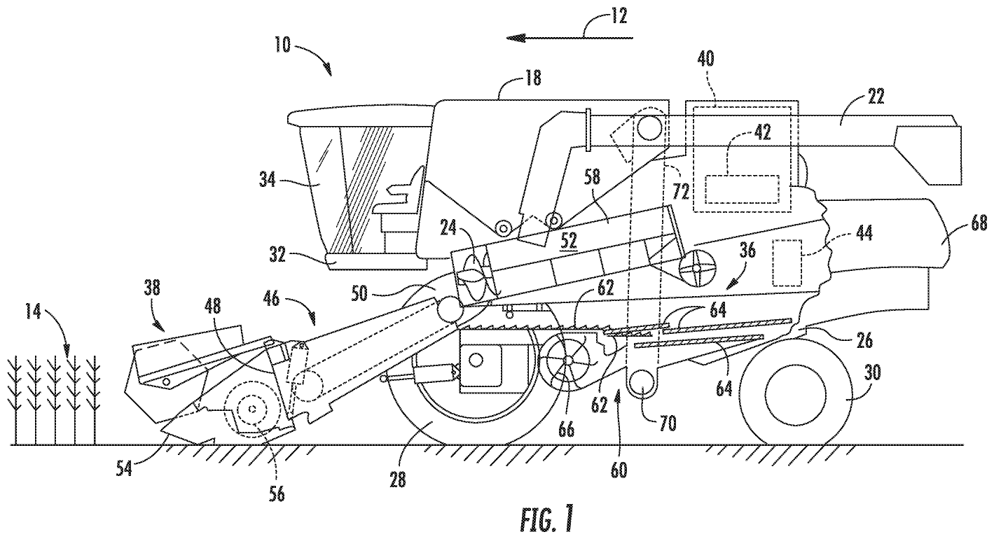

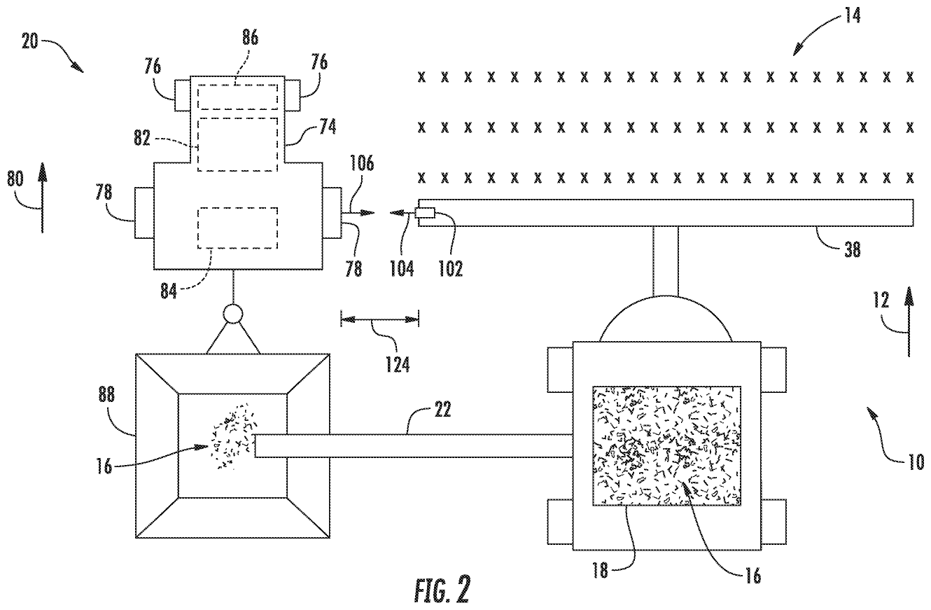

Referring now to the drawings, FIG. 1 illustrates a partial sectional side view of an agricultural harvester 10 in accordance with aspects of the present subject matter. In general, the harvester 10 may be configured to move across a field in a direction of travel (e.g., as indicated by arrow 12) to harvest a standing crop 14. While traversing the field, the harvester 10 may be configured to process the harvested crop 16 (FIG. 2) and store the harvested crop 16 within a crop tank 18 of the harvester 10. Furthermore, the harvested crop 16 may be unloaded from the crop tank 18 for receipt by the crop receiving vehicle 20 (FIG. 2) via a crop discharge tube 22 of the harvester 10.

As shown, in one embodiment, the harvester 10 may be configured as an axial-flow type combine, wherein the harvested crop 16 is threshed and separated while it is advanced by and along a longitudinally arranged rotor 24. However, it should be appreciated that, in alternative embodiments, the harvester 10 may have any other suitable harvester configuration.

The harvester 10 may include a chassis or main frame 26 configured to support and/or couple to various components of the harvester 10. For example, in several embodiments, the harvester 10 may include a pair of driven, ground-engaging front wheels 28 and a pair of steerable rear wheels 30 that are coupled to the frame 26. As such, the wheels 28, 30 may be configured to support the harvester 10 relative to the ground and move the harvester 10 in the direction of travel 12. Furthermore, the harvester 10 may include an operator's platform 32 having an operator's cab 34, a crop processing system 36, the crop tank 18, and the crop discharge tube 22 that are supported by the frame 26. As will be described below, the crop processing system 36 may be configured to perform various processing operations on the harvested crop 16 as the crop processing system 36 operates to transfer the harvested crop 16 between a harvesting implement (e.g., header 38) of the harvester 10 and the crop tank 18. Furthermore, the harvester 10 may include an engine 40 and a transmission 42 mounted on the frame 26. The transmission 42 may be operably coupled to the engine 40 and may provide variably adjusted gear ratios for transferring engine power to the wheels 28 via a drive axle assembly (or via axles if multiple drive axles are employed). Additionally, the harvester 10 may include a steering actuator 44 configured to adjust the orientation of the steerable wheels 30 relative to the frame 26. For example, the steering actuator 44 may correspond to an electric motor, a linear actuator, a hydraulic cylinder, a pneumatic cylinder, or any other suitable actuator coupled to suitable mechanical assembly, such as a rack and pinion or a worm gear assembly.

Moreover, as shown in FIG. 1, the header 38 and an associated feeder 46 of the crop processing system 36 may extend forward of the frame 26 and may be pivotally secured thereto for generally vertical movement. In general, the feeder 46 may be configured to serve as support structure for the header 38. As shown in FIG. 1, the feeder 46 may extend between a front end 48 coupled to the header 38 and a rear end 50 positioned adjacent to a threshing and separating assembly 52 of the crop processing system 36. As is generally understood, the rear end 50 of the feeder 46 may be pivotally coupled to a portion of the harvester 10 to allow the front end 48 of the feeder 46 and, thus, the header 38 to be moved upward and downward relative to the ground to set the desired harvesting or cutting height for the header 38.

As the harvester 10 is propelled forwardly over the field with the standing crop 14, the crop material is severed from the stubble by a sickle bar 54 at the front of the header 38 and delivered by a header auger 56 to the front end 48 of the feeder 46, which supplies the harvested crop 16 to the threshing and separating assembly 52. As is generally understood, the threshing and separating assembly 52 may include a cylindrical chamber 58 in which the rotor 24 is rotated to thresh and separate the harvested crop 16 received therein. That is, the harvested crop 16 is rubbed and beaten between the rotor 24 and the inner surfaces of the chamber 58, whereby the grain, seed, or the like, is loosened and separated from the straw.

The harvested crop 16 that has been separated by the threshing and separating assembly 52 may fall onto a crop cleaning assembly 60 of the crop processing system 36. In general, the crop cleaning assembly 60 may include a series of pans 62 and associated sieves 64. As is generally understood, the separated harvested crop 16 may be spread out via oscillation of the pans 62 and/or sieves 64 and may eventually fall through apertures defined in the sieves 64. Additionally, a cleaning fan 66 may be positioned adjacent to one or more of the sieves 64 to provide an air flow through the sieves 64 that remove chaff and other impurities from the harvested crop 16. For instance, the fan 66 may blow the impurities off of the harvested crop 16 for discharge from the harvester 10 through the outlet of a straw hood 68 positioned at the back end of the harvester 10. The cleaned harvested crop 16 passing through the sieves 64 may then fall into a trough of an auger 70, which may be configured to transfer the harvested crop 16 to an elevator 72 for delivery to the crop tank 18.

Referring now to FIG. 2, a top view of the harvester 10 unloading harvested crops 16 into the associated crop receiving vehicle 20 in accordance with aspects of the present disclosure. As shown, in one embodiment, the crop receiving vehicle 20 may be configured as an agricultural tractor. In such an embodiment, the crop receiving vehicle 20 may include a frame or chassis 74 configured to support or couple to a plurality of components. For example, a pair of steerable front wheels 76 and a pair of driven rear wheels 78 may be coupled to the frame 74. The wheels 76, 78 may be configured to support the crop receiving vehicle 20 relative to the ground and move the crop receiving vehicle 20 in a direction of travel 80 across the field. In this regard, the crop receiving vehicle 20 may include an engine 82 and a transmission 84 mounted on the frame 74. The transmission 84 may be operably coupled to the engine 82 and may provide variably adjusted gear ratios for transferring engine power to the driven wheels 78. Furthermore, the crop receiving vehicle 20 may include a steering actuator 86 configured to adjust the orientation of the steerable wheels 76 relative to the frame 74. For example, the steering actuator 86 may correspond to an electric motor, a linear actuator, a hydraulic cylinder, a pneumatic cylinder, or any other suitable actuator coupled to suitable mechanical assembly, such as a rack and pinion or a worm gear assembly. Moreover, the crop receiving vehicle 20 may be configured to tow a crop cart 88 configured to receive the harvested crop 16 discharged from the crop discharge tube 22 of the harvester 10. However, in other embodiments, the crop receiving vehicle 20 may be configured as any other suitable crop receiving vehicle known in the art, including an autonomous crop receiving vehicle. For example, in one embodiment, the crop receiving vehicle 20 may be an articulated tractor having four powered wheels or tracks.

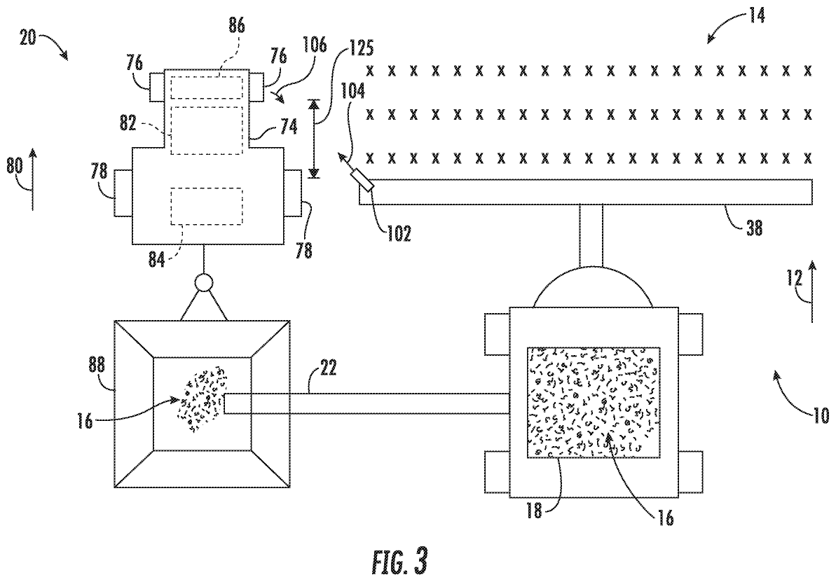

As shown in FIGS. 2 and 3, the harvester 10 may include a sensor 102 configured to emit one or more output signals (e.g., as indicated by arrow 104 in FIG. 2) for reflection off of the crop receiving vehicle 20. The output signal(s) 104 are, in turn, reflected by a component of the crop receiving vehicle 20 as return signals (e.g., as indicated by arrow 106 in FIG. 2). Moreover, the sensor 102 may be configured to receive the reflected return signal(s) 106. As shown in FIG. 2, in one embodiment, the sensor 102 may be mounted or coupled to the header 38 of the harvester 10, such as at location on the header 38 proximate to the vehicle 20, and oriented such that the output signal 104 is directed laterally (e.g., perpendicular to the direction of travel 12) at a component of the crop receiving vehicle 20 (e.g., the wheel 78). In another embodiment, as shown in FIG. 3, the sensor 102 may be mounted or coupled to the header 38 and oriented such that the output signal 104 is directed angularly (e.g., relative to the direction of travel 12) at a component of the crop receiving vehicle 20 (e.g., the wheel 76). However, it should be appreciated that the sensor 102 may be mounted and/or positioned at any other suitable location on harvester 10 in which the sensor 102 may emit the output signal(s) 104 toward the crop receiving vehicle 20, such as on the roof of the operator's cab 74. Furthermore, the sensor 102 may be mounted on the crop receiving vehicle 20 such that the sensor 102 may be configured to emit the output signal(s) 104 for reflection off of the harvester 10.

Additionally, it should be appreciated that the sensor 102 may generally correspond to any suitable sensing device configured to function as described herein, such as by emitting one or more output signals for reflection off of the crop receiving vehicle 20 (or, alternatively, the harvester 10) and by receiving or sensing the return signal(s). For example, in one embodiment, the sensor 102 may correspond to a radio detection and ranging (RADAR) sensor configured to emit one or more radio signals for reflection off of the crop receiving vehicle 20. However, in alternative embodiments, the sensor 102 may correspond to a light detection and ranging (LIDAR) sensor, an ultrasonic sensor, or any other suitable type of sensor.

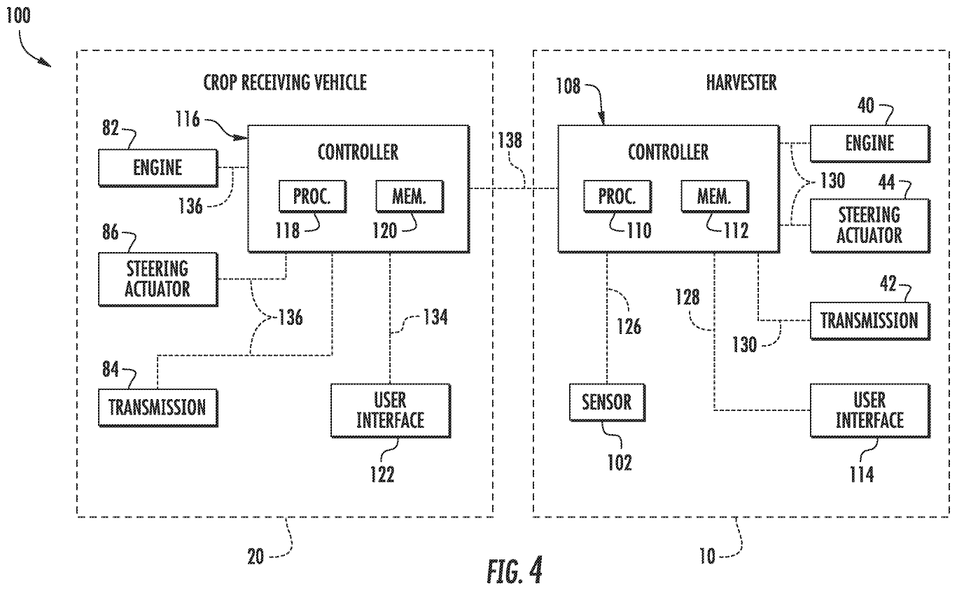

Referring now to FIG. 4, a schematic view of one embodiment of a system 100 for regulating the operating distance defined between work vehicles during the performance of field operations is illustrated in accordance with aspects of the present subject matter. In general, the system 100 will be described herein with reference to the harvester 10 and the crop receiving vehicle 20 described above with reference to FIGS. 1 and 2. However, it should be appreciated by those of ordinary skill in the art that the disclosed system 100 may generally be utilized with vehicles having any other suitable vehicle configuration. For example, in alternative embodiments, the system 100 may be used to regulate the operating distance between two agricultural tractors (e.g., when one tractor is pulling an unpowered harvesting device and the other tractor is pulling a crop crop), between a sugarcane harvester and an agricultural tractor pulling a crop cart, or any other suitable combination of vehicles.

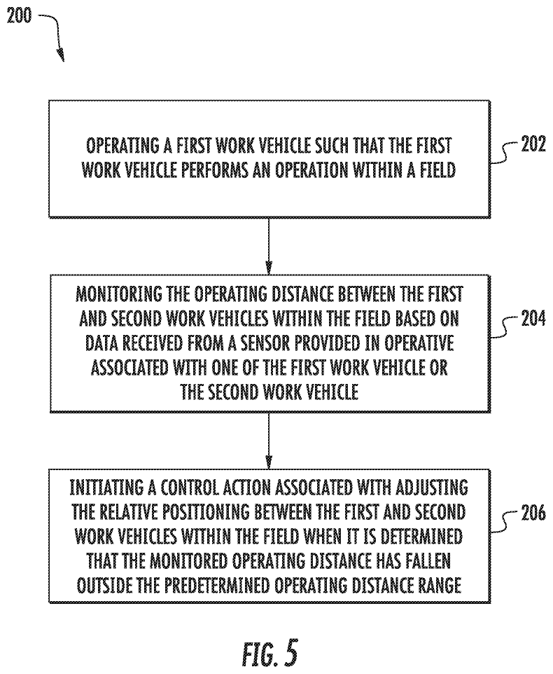

As shown in FIG. 4, the system 100 may include one or more harvester-based controllers 108 positioned on and/or within or otherwise associated with the harvester 10. In general, the harvester controller 108 may comprise any suitable processor-based device known in the art, such as a computing device or any suitable combination of computing devices. Thus, in several embodiments, the controller 108 may include one or more processor(s) 110 and associated memory device(s) 112 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 112 of the controller 108 may generally comprise memory element(s) including, but not limited to, a computer readable medium (e.g., random access memory (RAM)), a computer readable non-volatile medium (e.g., a flash memory), a floppy disc, a compact disc-read only memory (CD-ROM), a magneto-optical disc (MOD), a digital versatile disc (DVD), and/or other suitable memory elements. Such memory device(s) 112 may generally be configured to store suitable computer-readable instructions that, when implemented by the processor(s) 110, configure the implement controller 108 to perform various computer-implemented functions, such as one or more aspects of the method 200 described below with reference to FIG. 5. In addition, the implement controller 108 may also include various other suitable components, such as a communications circuit or module, one or more input/output channels, a data/control bus and/or the like.

It should be appreciated that the harvester controller 108 may correspond to an existing controller the harvester 10, itself, or the controller 108 may correspond to a separate processing device. For instance, in one embodiment, the harvester controller 108 may form all or part of a separate plug-in module that may be installed in association with the harvester 10 to allow for the disclosed systems and methods to be implemented without requiring additional software to be uploaded onto existing control devices of the harvester 10. It should also be appreciated that the functions of the harvester controller 108 may be performed by a single processor-based device or may be distributed across any number of processor-based devices, in which instance such devices may be considered to form part of the harvester controller 108.

Furthermore, in one embodiment, the system 100 may also include a user interface 114 of the harvester 10. More specifically, the user interface 114 may be configured to provide feedback (e.g., notifications related to the distance between the harvester 10 and the crop receiving vehicle 20) to the operator of the harvester 10. As such, the user interface 114 may include one or more feedback devices (not shown), such as display screens, speakers, warning lights, and/or the like, which are configured to communicate such feedback. In addition, some embodiments of the user interface 114 may include one or more input devices (not shown), such as touchscreens, keypads, touchpads, knobs, buttons, sliders, switches, mice, microphones, and/or the like, which are configured to receive user inputs from the operator. In one embodiment, the user interface 114 may be positioned within the cab 34 of the harvester 10. However, in alternative embodiments, the user interface 114 may have any suitable configuration and/or be positioned in any other suitable location.

Moreover, the system 100 may include one or more crop receiving vehicle-based controllers 116 positioned on and/or within or otherwise associated with the crop receiving vehicle 20. In general, the crop receiving vehicle controller 116 may comprise any suitable processor-based device known in the art, such as a computing device or any suitable combination of computing devices. Thus, in several embodiments, the controller 116 may include one or more processor(s) 118 and associated memory device(s) 120 configured to perform a variety of computer-implemented functions. Such memory device(s) 120 may generally be configured to store suitable computer-readable instructions that, when implemented by the processor(s) 118, configure the crop receiving vehicle controller 116 to perform various computer-implemented functions, such as one or more aspects of the method 200 described below with reference to FIG. 5. In addition, the crop receiving vehicle controller 116 may also include various other suitable components, such as a communications circuit or module, one or more input/output channels, a data/control bus and/or the like.

It should be appreciated that the crop receiving vehicle controller 116 may correspond to an existing controller the crop receiving vehicle 20, itself, or the controller 116 may correspond to a separate processing device. For instance, in one embodiment, the crop receiving vehicle controller 116 may form all or part of a separate plug-in module that may be installed in association with the crop receiving vehicle 20 to allow for the disclosed systems and methods to be implemented without requiring additional software to be uploaded onto existing control devices of the crop receiving vehicle 20. It should also be appreciated that the functions of the crop receiving vehicle controller 116 may be performed by a single processor-based device or may be distributed across any number of processor-based devices, in which instance such devices may be considered to form part of the crop receiving vehicle controller 116.

Additionally, in one embodiment, the system 100 may also include a user interface 122 of the crop receiving vehicle 20. More specifically, the user interface 122 may be configured to provide feedback (e.g., notifications related to the distance between the harvester 10 and the crop receiving vehicle 20) to the operator of the crop receiving vehicle 20. As such, the user interface 122 may include one or more feedback devices (not shown), such as display screens, speakers, warning lights, and/or the like, which are configured to communicate such feedback. In addition, some embodiments of the user interface 122 may include one or more input devices (not shown), such as touchscreens, keypads, touchpads, knobs, buttons, sliders, switches, mice, microphones, and/or the like, which are configured to receive user inputs from the operator. In one embodiment, the user interface 122 may be positioned within a cab of the crop receiving vehicle 20. However, in alternative embodiments, the user interface 114 may have any suitable configuration and/or be positioned in any other suitable location.

In several embodiments, the system 100 may be configured to sense the operating distance between the harvester 10 and the crop receiving vehicle 20. More specifically, as indicated above, the system 100 may include a sensor (e.g., sensor 102 shown in FIGS. 2 and 3) that is configured to emit the output signal(s) 104 toward the crop receiving vehicle 20 (or vice versa) for reflection off of a component thereof. Thereafter, the sensor 102 may be configured to receive or detect the associated reflected return signal(s) 108 corresponding to the emitted output signal(s) 104 as reflected off of the crop receiving vehicle 20. As such, the reflected return signals(s) 108 may be indicative of the operating distance between the harvester 10 and the crop receiving vehicle 20. As shown in FIG. 2, the sensor 102 may be configured to detect a lateral distance 124 defined between the harvester 10 and the crop receiving vehicle 20. For example, in one embodiment, a time duration or time-of-flight (TOF) defined between when the output signal(s) 104 is emitted by the sensor 102 and the reflected return signal(s) 108 is received by the sensor 102 may be indicative of the lateral distance 124. In another embodiment, the difference in the frequency of the signals 106, 108 may be indicative of the lateral distance 124. As shown in FIG. 3, the sensor 102 may be configured to detect a longitudinal distance 125 defined between the harvester 10 and the crop receiving vehicle 20, with the longitudinal distance being generally perpendicular to the lateral distance 124 (e.g., parallel to the direction of travel of the vehicles). For example, in one embodiment, a time duration or time-of-flight (TOF) defined between when the output signal(s) 104 is emitted by the sensor 102 and the reflected return signal(s) 108 is received by the sensor 102 may be indicative of the longitudinal distance 125. Based on the determined lateral distance 124 and the detected time duration or TOF, the longitudinal distance 125 may be determined. However, it should be appreciated that the operating distance between the harvester 10 and the crop receiving vehicle 20 may correspond to any other suitable distance defined therebetween.

Furthermore, in several embodiments, the harvester controller 108 of the system 100 may be configured to determine or monitor the operating distance between the harvester 10 and the crop receiving vehicle 20 based on data received from the sensor 102. Specifically, as shown in FIG. 4, the harvester controller 108 may be communicatively coupled to the sensor 102 via a wired or wireless connection to allow sensor data (e.g., indicated by dashed line 126 in FIG. 4) to be transmitted from the sensor 102 to the controller 108. In general, the sensor data 126 may be indicative of one or more characteristics of the output signal(s) 104 and/or the return signal(s) 106. As such, the harvester controller 108 may then be configured to determine the operating distance based on the output signal(s) 104 and/or the return signal(s) 106. For instance, the harvester controller 108 may include a look-up table or suitable mathematical formula stored within its memory 112 that correlates the sensor measurements (e.g., TOF data) to the current operating distance between the harvester 10 and the crop receiving vehicle 20. It should be appreciated that, in alternative embodiments, the crop receiving vehicle controller 116 may be communicatively coupled to the sensor 102 such that the controller 116 may be configured to determine the operating distance between the harvester 10 and the crop receiving vehicle 20.

In accordance with aspects of the present subject matter, the harvester controller 108 may further be configured to initiate a control action associated with adjusting the relative positioning between the harvester 10 and the crop receiving vehicle 20 when it is determined that the monitored operating distance has fallen outside a predetermined operating distance range. Specifically, in several embodiments, the harvester controller 108 may be configured to compare the values associated with the monitored operating distance to a predetermined operating distance range defined for the harvester 10 and the crop receiving vehicle 20. Thereafter, in the event that the monitored operating distance exceeds a maximum operating distance threshold for the given operating distance range or falls below a minimum operating distance threshold for such range (thereby indicating that the operating distance between of the harvester 10 and the crop receiving vehicle 20 may be too great or too small), the harvester controller 108 may be configured to initiate a control action associated with adjusting the relative positioning between the harvester 10 and the crop receiving vehicle 20 within the field. However, it should be appreciated that, in alternative embodiments, the vehicle controller 116 may configured to initiate the control action associated with adjusting the relative positioning between the harvester 10 and the crop receiving vehicle 20 as described above.

In one embodiment, the harvester controller 108 may be configured to notify the operator of harvester 10 that the monitored operating distance has fallen outside of the predetermined operating distance range. Specifically, as shown in FIG. 4, the harvester controller 108 may be communicatively coupled to the user interface 114 via a wired or wireless connection to allow feedback signals (e.g., indicated by dashed line 128 in FIG. 4) to be transmitted from the controller 108 to the user interface 114. As such, the harvester controller 108 may be configured to transmit feedback signals 128 to the user interface 114 instructing the user interface 114 to provide a notification to the operator of the harvester 10 (e.g., by causing a visual or audible notification or indicator to be presented to the operator within the cab 34 of the harvester 10) that provides an indication that the monitored operating distance has fallen outside of the predetermined operating distance range. In such instances, the operator may then choose to initiate any suitable corrective action he/she believes is necessary, such as by adjusting the direction of travel 12 and/or speed of the harvester 10. Additionally, in one embodiment, the user interface 114 may provide a visual or audible notification (e.g., a bar slider) of the operating distance between the harvester 10 and the crop receiving vehicle 20.

Moreover, in several embodiments, the harvester controller 108 may be configured to automatically adjust an operating parameter of the harvester 10 when it is determined that the monitored operating distance has fallen outside the predetermined operating distance range. Specifically, as shown in FIG. 4, the harvester controller 108 may be communicatively coupled to one or more components of the harvester 10, such as the engine 40, the transmission 42, and/or the steering actuator 44, via a wired or wireless connection to allow control signals (e.g., indicated by dashed lines 130 in FIG. 4) to be transmitted from the controller 108 to such components 40, 42, 44. As such, the harvester controller 108 may be configured to transmit control signals 130 to the engine 40, the transmission 42, and/or the steering actuator 44 instructing such components 40, 42, 44 to adjust the speed and/or direction of travel 12 of the harvester 10. For example, the control signals 130 may instruct the engine 40 to increase or decrease its power output to increase or decrease the speed at which the harvester 10 is moved across the field to adjust the longitudinal distance 125 between the harvester 10 and crop receiving vehicle 20. Similarly, the control signals 130 may instruct the transmission 42 to upshift or downshift to increase or decrease the speed at which the harvester 10 is moved across the field to adjust the longitudinal distance 125 between the harvester 10 and crop receiving vehicle 20. Moreover, the control signals 130 may instruct the steering actuator 40 to adjust the direction of travel 12 of the harvester 10, such as by steering the harvester 10 toward or away from the crop receiving vehicle 20, to adjust the lateral distance 124 between the harvester 10 and crop receiving vehicle 20.

Additionally, in one embodiment, the harvester controller 108 may be configured to limit a steering parameter of the harvester 10 when it is determined that the lateral distance 124 between the harvester 10 and the crop receiving vehicle 20 is too small. More specifically, in such instances, when the harvester operator inputs a steering command (e.g., via steering wheel (not shown) within the operator's cab 34), the harvester controller 108 may be configured to compare a parameter of such steering command (e.g., the rate or “sharpness” of the steering command) to a predetermined steering command limit. Thereafter, in the event that the parameter of the operator-inputted steering command exceeds the steering command limit (e.g., the steering command is too “sharp”), the harvester controller 108 may be configured to transmit control signals 130 to the steering actuator 44 instructing the steering actuator 44 to steer the harvester 10 in a manner such that the steering parameter limit is not exceeded.

In several embodiments, the harvester controller 108 may be configured to instruct the crop receiving vehicle controller 116 to control the operation of the crop receiving vehicle 20 when it is determined that the monitored operating distance has fallen outside the predetermined operating distance range. Specifically, as shown in FIG. 4, the harvester controller 108 may be communicatively coupled to the crop receiving vehicle controller 116 via a wired or wireless connection to allow instruction signals (e.g., indicated by dashed lines 138 in FIG. 4) to be transmitted from the harvester controller 108 to the crop receiving vehicle controller 116. For example, the instruction signals 138 may be transmitted from harvester controller 108 to the crop receiving vehicle controller 116 via any suitable vehicle-to-vehicle (V2V) communications protocols. Upon receipt of the instruction signals 138, the crop receiving vehicle controller 116 may be configured to control the operation of the crop receiving vehicle 20 in the manner instructed by the controller 108.

In one embodiment, the harvester controller 108 may be configured to initiate notification of the operator of crop receiving vehicle 20 that the monitored operating distance has fallen outside of the predetermined operating distance range. Specifically, as shown in FIG. 4, the crop receiving vehicle controller 116 may be communicatively coupled to the user interface 122 of the crop receiving vehicle 20 via a wired or wireless connection to allow feedback signals (e.g., indicated by dashed line 134 in FIG. 4) to be transmitted from the controller 116 to the user interface 122. As such, the harvester controller 108 may then be configured to transmit the instruction signals 138 to the crop receiving vehicle controller 116 instructing the crop receiving vehicle controller 116 to notify the operator of crop receiving vehicle 20 that the monitored operating distance has fallen outside of the predetermined operating distance range. In this regard, upon receipt of the instruction signals 138, the crop receiving vehicle controller 116 may then be configured to transmit feedback signals 134 to the user interface 122 instructing the user interface 122 to provide a notification to the operator of the crop receiving vehicle 20 (e.g., by causing a visual or audible notification or indicator to be presented to the operator within the cab of the vehicle 20) that provides an indication that the monitored operating distance has fallen outside of the predetermined operating distance range. In such instances, the operator may then choose to initiate any suitable corrective action he/she believes is necessary, such as by adjusting the direction of travel 12 and/or speed of the crop receiving vehicle 20.

Moreover, in several embodiments, the harvester controller 108 may be configured to initiate automatically adjustment of an operating parameter of the crop receiving vehicle 20 when it is determined that the monitored operating distance has fallen outside the predetermined operating distance range. Specifically, as shown in FIG. 4, the crop receiving vehicle controller 116 may be communicatively coupled to one or more components of the crop receiving vehicle 20, such as the engine 82, the transmission 84 and/or the steering actuator 86, via a wired or wireless connection to allow control signals (e.g., indicated by dashed lines 136 in FIG. 4) to be transmitted from the controller 116 to such components 32, 34, 36. As such, the harvester controller 108 may then be configured to transmit instruction signals 138 to the crop receiving vehicle controller 116 instructing the crop receiving vehicle controller 116 to control the operation of the components 32, 34, 36 of the crop receiving vehicle 20. In this regard, upon receipt of the instruction signals 138, the crop receiving vehicle controller 116 may then be configured to transmit control signals 136 to the engine 82, the transmission 84, and/or the steering actuator 86 instructing such components 32, 34, 36 to adjust the speed and/or direction of travel 12 of the crop receiving vehicle 20. For example, the control signals 136 may instruct the engine 82 to increase or decrease its power output to increase or decrease the speed at which the crop receiving vehicle 20 is moved across the field. Similarly, the control signals 136 may instruct the transmission 84 to upshift or downshift to increase or decrease the speed at which the crop receiving vehicle 20 is moved across the field. Moreover, the control signals 136 may instruct the steering actuator 86 to adjust the direction of travel 80 of the crop receiving vehicle 20, such as by steering the vehicle 20 toward or away from the harvester 10.

Additionally, in one embodiment, the harvester controller 108 may be configured to initiate limiting a steering parameter of the crop receiving vehicle 20 when it is determined that the lateral distance 124 between the harvester 10 and the crop receiving vehicle 20 is too small. More specifically, in such instances, the harvester controller 108 may then be configured to transmit instruction signals 138 to the crop receiving vehicle controller 116 instructing the crop receiving vehicle controller 116 to limit a steering parameter of the crop receiving vehicle 20. In this regard, upon receipt of the instruction signals 138, the crop receiving vehicle controller 116 may be configured to compare the operator steering command to a steering command limit provided by the harvester controller 108. Thereafter, in the event that the operator steering command exceeds the steering command limit (e.g., the steering command is too “sharp”), the crop receiving vehicle controller 116 may be configured to transmit control signals 136 to the steering actuator 86 instructing the steering actuator 86 to steer the crop receiving vehicle 20 in a manner such that the steering parameter limit is not exceeded.

It should be appreciated that, in alternative embodiments, the crop receiving vehicle controller 116 may be configured to initiate the above-described control actions without instruction from the harvester controller 108. For example, in such embodiments, the harvester controller 108 may be configured to transmit the sensor data 120 to the crop receiving vehicle controller 116, with the crop receiving vehicle controller 116 being configured to monitor the operating distance between the harvester 10 and the crop receiving vehicle 20 relative to the operating range and initiate any suitable control action(s) when the monitored operating distance falls outside of such range. Moreover, in one embodiment, the harvester controller 108 may be configured to transmit signals to the vehicle controller 116 indicating that the monitored operating distance falls outside of the operating range. Upon receipt of such signals, the crop receiving vehicle controller 116 may be configured to determine what control action(s) should be initiated. Furthermore, it should be appreciated that, in some embodiments, the crop receiving vehicle controller 116 may be configured to transmit instruction signals 138 to the harvester controller 108 instructing the harvester controller 108 to initiate particular control actions, such as when the sensor 102 is mounted on the crop receiving vehicle 20.

Referring now to FIG. 5, a flow diagram of one embodiment of a method 200 for regulating the operating distance defined between work vehicles during the performance of field operations is illustrated in accordance with aspects of the present subject matter. In general, the method 200 will be described herein with reference to the harvester 10, the crop receiving vehicle 20, and the system 100 described above with reference to FIGS. 1-3. However, it should be appreciated by those of ordinary skill in the art that the disclosed method 200 may generally be utilized to regulate the operating distance defined between any vehicles having any suitable vehicle configuration and/or in connection with any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include operating, with a computing device, a first work vehicle such that the first work vehicle performs an operation within a field. For instance, as described above, the harvester controller 108 may be configured to control the operation of the engine 40, the transmission 42, and/or the steering actuator 44 (e.g., via suitable control signals 130) of the harvester 10 such that the harvester 10 performs an operation (e.g., harvesting the standing crop 14) as the harvester 10 is moved across the field in the direction of travel 12.

Additionally, at (204), the method 200 may include monitoring, with the computing device, an operating distance between the first work vehicle and the second work vehicle within the field based on data received from a sensor provided in operative association with one of the first work vehicle or the second work vehicle. For instance, as described above, the harvester controller 108 may be communicatively coupled to the sensor 102 configured to capture data 126 indicative of the operating distance between the harvester 10 and the crop receiving vehicle 20. As such, data 126 transmitted from the sensor 102 may be received by the harvester controller 108 and subsequently analyzed and/or processed to determine the operating distance.

Moreover, as shown in FIG. 5, at (206), the method 200 may include initiating, with the computing device, a control action associated with adjusting a relative positioning between the first and second work vehicles within the field when it is determined that the monitored operating distance has fallen outside the predetermined operating distance range. As described above, such control actions may include controlling one or more components of the harvester 10 and/or the crop receiving vehicle 20. For instance, as indicated above, the harvester controller 108 may be configured to initiate notification of the operators of the harvester 10 and/or the crop receiving vehicle 20 indicating the monitored operating distance has fallen outside the predetermined operating distance range. Furthermore, the harvester controller 108 may be configured to automatically initiate a control action that results in a change of the speed and/or direction of travel 12, 80 of the harvester 10 and/or the crop receiving vehicle 20, such as by automatically controlling the operation of the corresponding engine 40, 82; transmission 42, 84; and/or steering actuator 44, 86. Additionally, the harvester controller 108 may be configured to initiate limiting of a steering parameter of the harvester 10 and/or the crop receiving vehicle 20.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system for regulating the operating distance defined between work vehicles during the performance of field operations, the system comprising:
a first work vehicle configured to traverse a field relative to a second work vehicle such that a predetermined operating distance range relative to the second work vehicle is maintained as the first work vehicle is traversed across the field;
a sensor provided in operative association with one of the first work vehicle, the sensor being configured to emit an output signal for reflection off of a component of the second work vehicle and detect the reflected output signal as a return signal; and p1 a controller communicatively coupled to the sensor, the controller being configured to monitor an operating distance between the first and second work vehicles within the field based on data received from the sensor associated with at least one of the output signal or the return signal, the controller further being configured to initiate a control action associated with adjusting a relative positioning between the first and second work vehicles within the field when it is determined that the monitored operating distance has fallen outside the predetermined operating distance range.

2. The system of claim 1, wherein the sensor corresponds to at least one of a radio detection and ranging (RADAR) sensor, a light detection and ranging (LIDAR) sensor, or an ultrasonic sensor.

3. The system of claim 1, wherein the controller is further configured to notify an operator of at least one of the first work vehicle or the second work vehicle that the monitored operating distance has fallen outside of the predetermined operating distance range.

4. The system of claim 1, wherein the controller is configured to adjust at least one of a direction of travel or a ground speed of the first work vehicle to adjust the relative positioning of the first and second work vehicles within the field.

5. The system of claim 1, wherein the predetermined operating distance range specifies a minimum distance threshold to be provided between the first and second work vehicles within the field, the controller being configured to limit a steering parameter of the first work vehicle in a direction that would cause the monitored operating distance to fall below the minimum distance threshold.

6. The system of claim 1, wherein the controller is configured to transmit data to a second controller provided in operative association with the second work vehicle, the data being associated with instructing the second controller to adjust an operating parameter of the second work vehicle when it is determined that the monitored operating distance has fallen outside the predetermined operating distance range.

7. The system of claim 1, wherein the first work vehicle comprises an agricultural harvester.

8. The system of claim 7, wherein the harvester comprises a harvesting implement configured to harvest crop materials from the field, the sensor is installed on a portion of the harvesting implement and being configured to emit the output signal for reflection off of the component of the second work vehicle.

9. The system of claim 8, wherein the harvesting implement comprises a header.

10. A system for regulating the operating distance defined between work vehicles during the performance of field operations, the system comprising:
an agricultural harvester including a harvesting implement configured to perform a harvesting operation within a field;
a crop receiving vehicle configured to be maintained within a predetermined operating distance range relative to the harvester as the harvester is performing the harvesting operation within the field;
a sensor installed on the harvesting implement, the sensor being configured to emit an output signal for reflection off of a component of the crop receiving vehicle and detect the reflected output signal as a return signal; and
a controller communicatively coupled to the sensor, the controller being configured to monitor an operating distance between the harvester and the crop receiving vehicle within the field based on data received from the sensor associated with at least one of the output signal or the return signal, the controller further being configured to initiate a control action associated with adjusting a relative positioning between the harvester and the crop receiving vehicle within the field when it is determined that the monitored operating distance has fallen outside the predetermined operating distance range.

11. The system of claim 10, wherein the sensor corresponds to at least one of a radio detection and ranging (RADAR) sensor, a light detection and ranging (LIDAR) sensor, or an ultrasonic sensor.

12. A method for regulating the operating distance defined between a first work vehicle and a second work vehicle during the performance of field operations, the first work vehicle being configured to perform an operation within a field, the second work vehicle configured to be maintained within a predetermined operating distance range relative to the first work vehicle as the first work vehicle is performing the operation within the field, the method comprising:
operating, with a computing device, a first work vehicle such that the first work vehicle performs an operation within a field;
monitoring, with the computing device, an operating distance between the first and second work vehicles within the field based on data received from a sensor provided in operative association with one of the first work vehicle or the second work vehicle, the sensor being configured to emit an output signal for reflection of a component of the other of the first work vehicle or the second work vehicle and detect the reflected output signal as a return signal, the data being associated with at least one of the output signal or the return signal; and
initiating, with the computing device, a control action associated with adjusting a relative positioning between the first and second work vehicles within the field when it is determined that the monitored operating distance has fallen outside the predetermined operating distance range.

13. The method of claim 12, wherein the sensor corresponds to at least one of a radio detection and ranging (RADAR) sensor, a light detection and ranging (LIDAR) sensor, or an ultrasonic sensor.

14. The method of claim 12, further comprising:
notifying, with the computing device, an operator of at least one of the first work vehicle or the second work vehicle that the monitored operating distance has fallen outside of the predetermined operating distance range.

15. The method of claim 12, further comprising:
adjusting, with the computing device, at least one of a direction of travel or a ground speed of at least one of the first work vehicle or the second work vehicle to adjust the relative positioning of the first and second work vehicles within the field.

16. The method of claim 12, wherein the predetermined operating distance range specifies a minimum distance threshold to be provided between the first and second work vehicles within the field, the method further comprising:
limiting, with the controller, a steering parameter of at least one of the first work vehicle or the second work vehicle in a direction that would cause the monitored operating distance to fall below the minimum distance threshold.

17. The method of claim 12, further comprising:
adjusting, with the computing device, an operating parameter of the first work vehicle when it is determined that the monitored operating distance has fallen outside the predetermined operating distance range.

18. The method of claim 12, further comprising:
transmitting, with the computing device, data to a controller associated with the second work vehicle, the data associated with instructing the controller to adjust an operating parameter of the second work vehicle when it is determined that the monitored operating distance has fallen outside the predetermined operating distance range.

19. The method of claim 12, wherein the first work vehicle comprises an agricultural harvester and the second work vehicle comprises a crop receiving vehicle.
